(19) United States
(12) Patent Application Publication
(10) Pub. No.: US 2014/0352196 A1
(43) Pub. Date: Dec. 4, 2014

(54) FISHING ROD HOLDER

(71) Applicant: James A. Copeland, Oakmont, PA (US)

(72) Inventor: James A. Copeland, Oakmont, PA (US)

(21) Appl. No.: 14/292,608

(22) Filed: May 30, 2014

Related U.S. Application Data
(60) Provisional application No. 61/956,003, filed on May 30, 2013.

(51) Int. Cl. A01K 97/10; E04H 12/22; A01K 97/01; E02D 5/80; A01K 93/02; A01K 97/12

(52) U.S. Cl. CPC A01K 97/10; A01K 93/02; A01K 97/12; A01K 97/01; E02D 5/801; E04H 12/2223
USPC 43/17; 43/21.2

(57) ABSTRACT

An improved fishing rod holder comprises: a vertical stake capable of inserting into the ground; a bracket connected substantially perpendicular to that stake; a plurality of prongs affixed to the bracket, at least one prong opening in a first direction and another prong opening in an opposite direction, said prongs adapted for holding a fishing rod. The holder further includes a magnetic connector affixed along the bracket and bobber element that has a magnetic head connect at one end, a fishing line guidance shaft at the opposite end and a signal bell adjacent the line guidance shaft.

### CROSS-REFERENCE TO RELATED APPLICATION

This application is a perfection of Provisional Application Ser. No. 61/956,003, filed on May 30, 2013, the disclosure of which is fully incorporated herein.

### BACKGROUND OF THE INVENTION

1. Technical Field

The present invention relates to improvements for supporting a fishing rod and more particularly to a stand or holder upon which a fishing rod can be placed and adequately held while the fisherman rests or performs other duties. The present stand is being promoted as an improved Quick Stand™ holder, “the Fishing Stand in Demand”.

2. Relevant Art

Numerous fishing stands are known such as the forked stand of Mart U.S. Pat. No. 2,555,982 and V-shaped flip stand of Walsh U.S. Pat. No. 2,622,829 to name just a few.

An important object of the present invention is to provide a fishing rod stand that readily sets up for holding a fishing rod in a steady and secure manner, yet signals when a strike occurs and permits the rod to be removed for reeling in the catch. Preferably, that stand/holder secures into the ground (sand or dirt). Alter ate versions include an auger for ice fishing and a clamp for affixing to a boat railing.

Another object is to provide a fishing rod holder upon which a rod can be supported and easily adjusted as may be desired under certain conditions.

A further object of the invention is to provide a fishing rod stand that can be disassembled and carried to a use site or stored in a small compartment.

These and various other objects and advantages of the invention become apparent from the following description.

### SUMMARY OF THE INVENTION

This invention concerns an improved fishing rod holder that comprises: a stake capable of inserting into the ground; a bracket connected substantially perpendicular to that stake; a plurality of prongs affixed to the bracket, at least one prong opening in a first direction and another prong opening in an opposite direction, said prongs adapted for holding a fishing rod. The holder stand further includes a magnetic connector affixed along the bracket and a bobber element with a magnetic head connect at one end and a fishing line guidance shaft at the opposite end. A signal bell preferably extends from the same end as the line guidance shaft.

Ideally, the aforementioned holder includes means for joining the stake to a fishing rod shaft during transport. Representative means include one or more Velcro straps, flexible plastic clamps and combinations thereof. In alternate variations (or options), an auger bit may be added to the lower end of the stake (or replaced altogether with a drill bit ended stake, to make the holder/stand suitable for ice fishing. Should the whole unit be applied to a fishing pier or boat having railings, a further optional clamping means may be used to supplement the mounting of this invention to a horizontal extension.

### SUMMARY OF THE DRAWINGS

Further features, objects and advantages of this invention will be made clearer from the following detailed description made with reference to the accompanying drawings in which:

FIG. 1 is a top exploded view showing the various components of this invention with a close up top view of the fishing rod holding elements to the left of the fully assembled unit;

FIG. 2 is a top perspective view of the fishing rod holding elements and bobber;

FIG. 3 is atop plan view showing a fishing rod positioned on and secured to the invention for transport to a fishing site;

FIG. 4 is a side view showing a fishing rod positioned on the invention prior to securing into the ground;

FIG. 5 is a top plan view of a fishing rod on the invention ready for use with the bobber duly positioned;

FIG. 6 is a top plan view of the invention (with fishing rod removed for greater visibility) showing the bobber in place;

FIG. 7 is a right side view of the invention and bobber from FIG. 6;

FIG. 8 is a top plan view of an optional auger bottom for ice fishing; and

FIG. 9 is a top plan view of one version of clamp for use of the device on a boat railing.

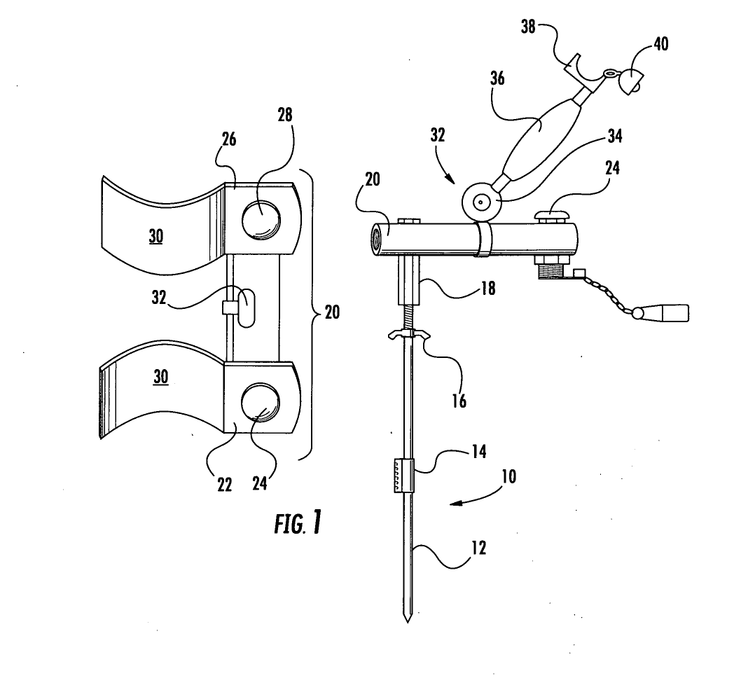

### DETAILED DESCRIPTION OF PREFERRED EMBODIMENTS

Referring to the accompanying FIGS., there is shown a fishing rod holder or stand, generally 10. A main component of this stand is its vertically extending stake 12, preferably made from aluminum tubing (or steel, in the alternative). Along the shaft of this stake 12, there are positioned at least one, preferably two wraps of hook-and-loop (or Velcro®) tape 14. That tape is used to secure the invention to its fishing rod proper F during transport to the ultimate fishing site/location.

Towards the top end of stake 12, there is a wing nut 16 that joins a threaded end to rod coupling 18. In turn, that rod coupling 18 affixes to a horizontally extending bracket 20, one embodiment of which is made from a turnbuckle. At one end of bracket 20, there is a first prong, generally 22, joined to bracket 20 via carriage bolt and nut combination 24. A second prong 26 extends from the opposite end of bracket 20 and connects via its own carriage bolt and nut combination 28.

Each prong 22, 26 has a flexible extension 30 that to better protect the fishing rod handle H has a section of shrinkable tubing inserted thereover. These extensions 30 are meant to bend and better grip about the handle H for holding the fishing rod proper with the present invention.

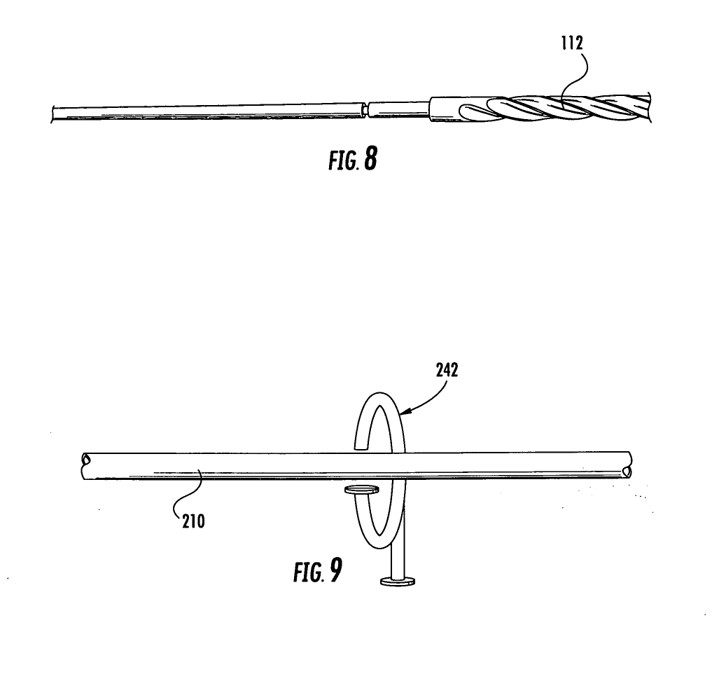

Between the two prongs and raised slightly above the upper surface of bracket 20, there is a magnetic clasp or connector 32. it partners with a magnetic head connect 34 at one end of bobber element 36. At the opposite end to that bobber 36, there is a fishing line guidance shaft 38 with an alarm-sounding bell 40 adjacent to it. Shaft 38 and bell 40 will notify the device's user when a fish strike on the line threaded into or through shaft 38 has occurred causing it to advance forward ever so slightly and thus causing bell 40 to ring. Alternate embodiments (or optional variations) include the auger tipped stake end 112 of FIG. 8 and C-clamp connector 242 in FIG. 9, the latter serving as means for attaching that device 210 to a horizontally extending bar or railing as might be found on a fishing pier or boat deck (when no “ground” is available for otherwise inserting a stake end in).

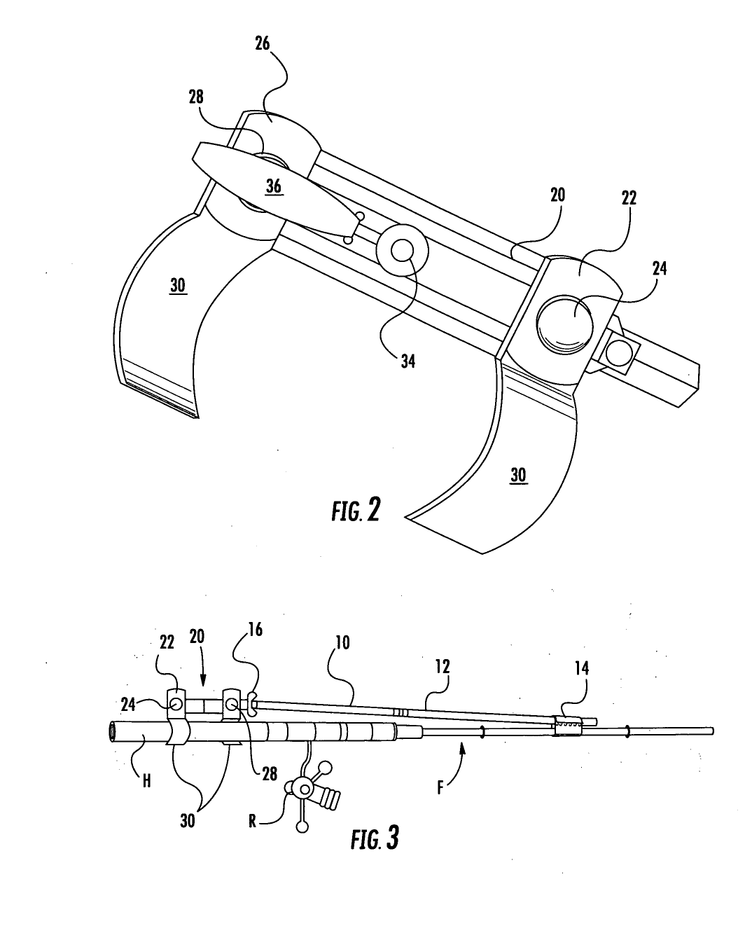

A more detailed breakdown of the main product views, for FIGS. 2 through 6 follows below:

FIG. 2—Top view of stand holder with the magnetic bobber/fish strike indicator.
1) turnbuckle—main piece of hardware where everything attaches.
2) two (1) hole strap conduits attach to turnbuckles with shrinkable tubing for protective covering to form prongs.
3) carriage bolt—connects conduit to turnbuckle.
4) coupling nut—attaches to carriage bolt on opposite side for stake insert to place in ground.
5) mounting cable tie: attaches to one side of turnbuckle with magnetic clasp (or connector) placed thereon.
6) grommet magnet placed into eye hook then glued and then placed into grommet.
7) eye hook—threaded part of eye hook inserts into peg.
8) peg—slides into bobber.
9) bobber—slides into peg.
10) electrical conduit—attaches to peg with wire shaft.
11) bell—attaches to wire shaft then inserts into peg and slides into a top end of bobber.

FIG. 3—view of stand secured to a fishing rod during transport
1) 18″ aluminum rod (stake)
2) wingnut
3) (2) one hole conduits
4) grommet
5) Velcro strap approx. 5″
6) shrinkable tubing for easy grip stand attaches to rod by sliding handle of rod into conduits then Velcro strap wraps around rod.

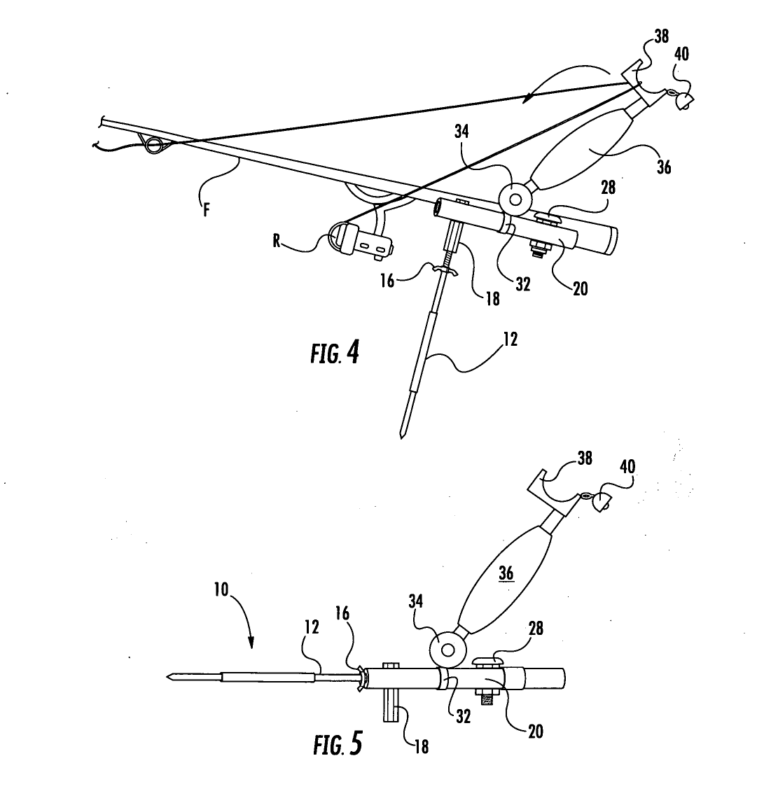

FIG. 4—shows how assembled stand and bobber unit works
1) stake assembly
2) reel (element R in the drawings)
3) rod placed in stand with fishing line out and bobber assembly in.
4) Backward position line is taken from reel and placed around conduit.

When a fish strikes, it pulls unit forward with the fishing line sliding out of its guide for quick rod release.

FIG. 5—side view of stake on rod

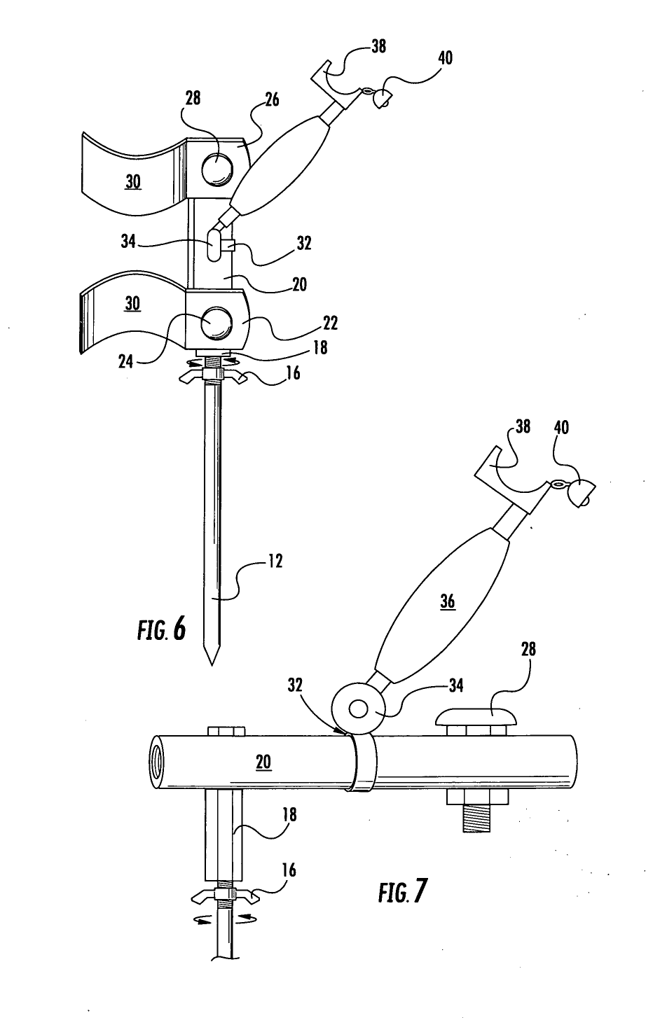

FIG. 6—shows how stake inserts at counter clockwise position to the wing nut from turnbuckle. It then inserts into the assembly by screwing to coupling nut and tightening wing nut for security.

### Transport of the Holder/Stand to a Fishing Rod

1. Slide fishing rod handle into the pair of prongs for this holder/stand. Note that thickness of rod handles can vary. To accommodate different fishing rod handle sizes and shapes, both prongs can be slightly bent based on the rod handle being held with this invention. To further adjust firmly about that rod handle, extra washers can be inserted where indicated above or spacing washers subtracted therefrom for smaller rod handles.

2. Once the fishing rod handle is set into these prongs, it should still be able to swing with light tension to align (almost parallel) with the body of the fishing rod itself. If not satisfied with tension, one can readjust the spacing of washers, etc. Velcro straps can then further secure the holder/stand to its fishing rod for safe transport and security.

3. After reaching one's desired fishing location, first unwrap the Velcro straps from about the stake to separate it from the fishing rod proper. Then, loosen the wing nut for removing the stake from the rest of the holder/stand unit. Place the stake into its coupling nut and tighten the wing nut. With the palm of one's hand, firmly push stand into ground (use your other hand to guide stake into ground where preferred).

4. When the holder/stand is secured into the ground and reconnected via the coupling and wing nuts, it is “ready” for use to fish with.

5. After casting into the water, insert the handle of the rod into holder's prong pair (but not too far back as quickness of the rod release may cause a slow release action).

6. Take fishing line from the reel. Pull back on line with sufficient tension to situate said line around clip located on one end of bobber. When fish strikes, bobber will be pulled forward and line will instantly slide out of clip with quick rod release.

Entire bobber unit can be slid on wire to an almost “standing position” for a lighter strike. This bobber can also be adjusted for a heavier current by adding weight to the top of the wire with a split shot.

While certain illustrative embodiments have been shown in the photographs and described above in considerable detail, it should be understood that there is no intention to limit the invention to the specific forms disclosed.

What is claimed is:

1. A fishing rod holder comprising:
a stake capable of ground insertion;
a bracket connected substantially perpendicular to the stake;
a plurality of prongs affixed to the bracket, at least one prong opening in a first direction and another prong opening in an opposite direction, said prongs adapted for holding a handle of the fishing rod;
a magnetic connector affixed along the bracket; and
a bobber element that has a magnetic head connect at one end, a fishing line guidance shaft at the opposite end and a signal bell adjacent the line guidance shaft.

2. The fishing rod holder of claim 1 wherein the stake extends substantially vertical when inserted into the ground.

3. The fishing rod holder of claim 1 wherein the stake comprises aluminum tubing.

4. The fishing rod holder of claim 1 wherein the bracket has two prongs affixed thereto.

5. The fishing rod holder of claim 4 wherein a first prong opens upwardly and a second prong opens downwardly.

6. The fishing rod holder of claim 4 wherein each prong has a flexible extension for shaping about the fishing rod handle.

7. The fishing rod holder of claim 1 wherein the magnetic connector extends upwardly above an upper surface of the bracket.

8. The fishing rod holder of claim 1, which further includes means for securing the rod holder to the fishing rod during transport.

9. The fishing rod holder of claim 8 wherein the securing means includes a plurality of sections of hook-and-loop fastener tape.

10. The fishing rod holder of claim 8 wherein the securing means includes a plurality of plastic clips or clamps.

11. The fishing rod holder of claim 1 wherein the stake has a lower auger tip for ice fishing.

12. The fishing rod holder of claim 1, which further includes means for clamping said rod holder to a horizontal bar or railing.

13. A fishing rod holder comprising:
a vertical stake capable of ground insertion;
a bracket connected substantially perpendicular to the stake;
a pair of prongs affixed to opposite ends of the bracket, a first prong opening in a first direction and a second prong opening in an opposite direction, said prongs adapted for holding a handle of the fishing rod;
a magnetic connector affixed to the bracket above an upper surface of the bracket; and
a bobber element that has a magnetic head connect at one end, a fishing line guidance shaft at the opposite end and a signal bell adjacent the line guidance shaft.

14. The fishing rod holder of claim 13 wherein the first prong opens upwardly and the second prong opens downwardly.

15. The fishing rod holder of claim 13 wherein each prong has a flexible extension for shaping about the fishing rod handle.

16. The fishing rod holder of claim 13, which further includes means for securing the rod holder to the fishing rod during transport.

17. The fishing rod holder of claim 16 wherein the securing means includes a plurality of sections of hook-and-loop fastener tape.

18. The fishing rod holder of claim 16 wherein the securing means includes a plurality of plastic clips or clamps.

19. The fishing rod holder of claim 13 wherein the stake has a lower auger tip for ice fishing.

20. The fishing rod holder of claim 13, which further includes means for clamping said rod holder to a horizontal bar or railing.
